(19) United States
(12) Patent Application Publication
(10) Pub. No.: US 2019/0159268 A1
(43) Pub. Date: May 23, 2019

(54) ONLINE SIGN-UP IN NEUTRAL HOST NETWORKS

(71) Applicant: Telefonaktiebolaget LM Ericsson (publ), Stockholm (SE)

(72) Inventors: Daniel Nilsson, Älvängen (SE); Qian Chen, Mölndal (SE); Patrik Dannebro, Hisings Kärra (SE)

(21) Appl. No.: 16/301,858

(22) PCT Filed: May 30, 2017
(86) PCT No.: PCT/EP2017/063036

§ 371 Date: Nov. 15, 2018

Related U.S. Application Data
(60) Provisional application No. 62/347,213, filed on Jun. 8, 2016.

(51) Int. Cl. H04W 76/10

(52) U.S. Cl. CPC H04W 76/10

(57) ABSTRACT

Disclosed herein is a method of operation of a network node and a corresponding network node in a Neutral Host Network (NHN) in relation to an Online Set Up (OSU) procedure by which User Equipment devices (UEs) are enabled to access a data network via the NHN where the NHN comprises one or more Access Points (APs) that provide wireless access according to a cellular communications technology. The method of operation of the network node comprises: obtaining a filter list that defines limitations on a connectivity of a Packet Data Network (PDN) connection established for OSU between a UE and a Participating Service Provider (PSP); and utilizing the filter list such that traffic on the PDN connection is limited to traffic between the UE and one or more other network nodes of the PSP that perform operations related to OSU.

### TECHNICAL FIELD

The present disclosure relates to Online Sign Up (OSU) in a Neutral Host Network (NHN) and, in particular, relates to OSU in a NHN for, e.g., MulteFire Access Points (APs).

### BACKGROUND

The mobile industry is preparing for a large increase in mobile data traffic. In order to meet this demand, cellular communications networks, such as Third Generation Partnership Project (3GPP) Long Term Evolution (LTE), are being enhanced to utilize unlicensed frequency spectrum (e.g., the 5 Gigahertz (GHz) spectrum). In particular, LTE in unlicensed spectrum (LTE-U) and License Assisted Access (LAA) are being developed and standardized. LTE-U and LAA utilize Carrier Aggregation (CA) with an anchor in a licensed spectrum and one or more additional carriers in the unlicensed spectrum to deliver improved network performance.

MulteFire is a new LTE based technology that is being developed by the MulteFire Alliance (MFA). Unlike LTE-U and LAA, MulteFire is an LTE-based technology that operates solely in unlicensed spectrum (i.e., MulteFire does not require an anchor in a licensed spectrum). MulteFire may more generally be referred to as standalone LTE in unlicensed spectrum.

MulteFire, or standalone LTE in unlicensed spectrum, should be designed with the flexibility of using either a traditional Public Land Mobile Network (PLMN) Evolved Packet Core (EPC) or directly using an Internet Protocol (IP) network for connectivity. The latter case gives rise to a so-called Neutral Host Network (NHN) mode in which multiple operators can share a single NHN identity (ID) across standalone cells without having to deploy separate radio access networks. User Equipment devices (UEs) are consequently given increased flexibility in how they connect to the MulteFire network: either with a PLMN subscription or with a subscription to a service provider (i.e., a Participating Service Provider (PSP)) affiliated with the NHN.

Like PLMNs, each NHN is a self-contained ‘standalone’ deployment. NHNs may support Neutral Host (NH) compliant UEs or similar wireless communication devices associated with a subscription from a PSP. The NHN authenticates and authorizes a device to connect using either a PSP Authentication, Authorization, and Accounting (AAA) or a 3GPP AAA. Once authorized, the NHN provides the device with IP connectivity to an external IP network.

Using this architecture, one NHN can offer access to subscribers from multiple PSPs. The relationship between a NHN and a PSP can either be untrusted or trusted. If untrusted, then the NHN only gets the possibility to authenticate UEs via PSP/3GPP AAA. If trusted, then the NHN can have more subscription information.

Inband online signup is a procedure an end user/UE can do if a new subscription should be created for any of the supported PSPs in a NHN. Then, the UE is using the NHN access to sign up for a new subscription in one PSP. It is important that this first access via NHN access can only be used for Online Sign Up (OSU) as the UE at that point doesn't have a valid subscription.

FIG. 1 depicts one possible way to implement OSU currently being specified in MFA. The call flow is described briefly here:
1. The UE discovers a MulteFire (MF) Access Point (AP) and performs service discovery to receive information of Online Credential Provisioning.
2. The Provisioning function in the UE initiates the online provisioning by requesting, over Non-Access Stratum (NAS) protocol, connectivity to provide temporary access for credential provisioning. The UE performs an Attach procedure indicating that the UE is seeking online provisioning of credentials. How this is indicated is for further study; however, one possible example is use of specific AP Name (APN)—‘OSU.’
3. The NH Mobility Management Entity (MME) initiates Extensible Authentication Protocol (EAP) to authenticate the device. The user ID used is of the form anonymous@OSU.<ServiceProviderRealm>. The NH MME uses realm to start the EAP procedure with a corresponding PSP's OSU AAA server. Note: The PSP OSU AAA server may be the same or different from the PSP AAA for normal service.
4. If EAP Transport Layer Security (TLS) is successful, a Master Session Key (MSK) is provided to the NH MME NAS and the UE NAS. K_{ASME} (Access Security Management Entity (ASME) Key) is derived from the MSK, and from there all security keys are derived as depicted.
5. The UE and the network continue the attach procedure, starting with Security Mode Command (SMC) to create a new security context. This security context is only valid during the provisioning process, i.e., the UE enters a substate of EMM-REGISTERED that does not allow normal service, only access a Packet Data Network (PDN) connection restricted to provisioning with a specific (set of) OSU server(s).
6. The interaction with the OSU server is handled by the Provisioning function in the UE. The UE initiates the Subscription selection and credentials provisioning with the OSU Server over Hypertext Transfer Protocol over Transport Layer Secure (HTTPS), using Open Mobile Alliance (OMA) Device Management (DM) or Simple Object Access Protocol (SOAP) Extensible Markup Language (XML), as defined for Hotspot S2.0. The OSU server shall request and the UE shall provide the device certificate. Validating the device certificate is up to the PSP policy (but it is recommended).
7. Upon successful provisioning of the device, the OSU server updates the AAA server about this new subscription information.
8. The Detach procedure is initiated to remove the UE context for provisioning only. A Radio Resource Control (RRC) connection is released during the detach procedure.
9. The UE establishes a new RRC connection and performs an attach procedure using the new set of credentials.

### SUMMARY

Some problems/challenges to provide Online Sign Up (OSU) services in a Neutral Host Network (NHN) are:
1. How to achieve limited connectivity on the connection so it can only be used for OSU and not as a general purpose connection.
2. How to make the NHN transparent to OSU so there is no need to configure Participating Service Provider (PSP) specific parameters in the NHN. This could for example be the configuration of the Internet Protocol (IP) address(es) of the PSP OSU server(s).
3. The NHN should not be able to steer end users to specific PSPs where for instance the NHN gets paid more for each new subscription. If end users have selected a certain PSP for a new subscription it shall not be possible for the NHN to re-direct them to another PSP.

With minimal configuration in the NHN per PSP supported, a secure OSU procedure is defined. The NHN doesn't have to be aware and provisioned with the IP addresses used by the PSP OSU servers. This configuration might be subject to frequent changes and requires coordination between the NHN and the PSP. The NHN can be assured that only traffic to/from IP addresses authorized by PSP flows during the OSU phase.

It is proposed that:
1. The OSU Authentication, Authorization, and Accounting (AAA) server sends OSU server IP address(es) to the NHN (local AAA proxy or the Neutral Host (NH) Mobility Management Entity (MME)) so that the NHN can setup a connection for the User Equipment device (UE) that is limited to only access those specific IP addresses. This information is not relayed to the UE since the UE can't trust the information.
2. If the NHN is realized by a Long Term Evolution (LTE)/Evolved Packet Core (EPC) like network, the MME can receive the OSU server IP address in the form of IP address filter(s) and then it can setup a Packet Data Network (PDN) connection that can only be used for accessing the OSU servers (e.g., using General Packet Radio Service Tunneling Protocol version 2 (GTPv2) Traffic Flow Templates (TFTs)). In some embodiments, the NH Gateway (GW) (e.g., PDN Gateway (P-GW)) obtains the filter(s), in for example the TFT information element, that will deny all traffic except the traffic to the IP address(es) of the OSU server(s). In that way, the PDN connection will be limited to only access the OSU server(s).
3. In another solution, the NH GW receives the OSU server IP address IP filter(s) directly from the NHN local AAA proxy during setup of a PDN connection. When applying the filter(s) the PDN connection can only be used for accessing the OSU servers. In some embodiments, the NH GW (e.g., P-GW) obtains the filter(s) from the NHN local AAA proxy during setup of the PDN connection, where the filter(s) will deny all traffic except the traffic to the IP address(es) of the OSU server(s). In that way, the PDN connection will be limited to only access the OSU server(s).
4. The OSU AAA server sends the OSU server IP address encrypted to the UE.

One embodiment of the present solution is directed to a method of operation of a network node that performs OSU AAA for a PSP to enable UEs to access a data network via a NHN that comprises one or more APs that provide wireless access according to a cellular communications technology. The method comprises: providing, to another network node in the NHN, a filter list that defines limitations on a connectivity of a PDN connection established for OSU between a UE and the PSP.

Another embodiment of the present solution is directed to a network node that performs OSU AAA for a PSP to enable UEs to access a data network via a NHN that comprises one or more APs that provide wireless access according to a cellular communications technology. The network node is adapted to operatively: provide, to another network node in the NHN, a filter list that defines limitations on a connectivity of a PDN connection established for OSU between a UE and the PSP.

Another embodiment of the present solution is directed to a network node that performs OSU AAA for a PSP to enable UEs to access a data network via a NHN that comprises one or more APs that provide wireless access according to a cellular communications technology. The network node comprises: at least one processor and memory storing instructions executable by the at least one processor whereby the network node is operable to provide, to another network node in the NHN, a filter list that defines limitations on a connectivity of a PDN connection established for OSU between a UE and the PSP.

Another embodiment of the present solution is directed to a network node that performs OSU AAA for a PSP to enable UEs to access a data network via a NHN that comprises one or more APs that provide wireless access according to a cellular communications technology. The network node comprises: a filter list providing module operable to provide, to another network node in the NHN, a filter list that defines limitations on a connectivity of a PDN connection established for OSU between a UE and the PSP.

Another embodiment of the present solution is directed to a method of operation of a network node in a NHN in relation to an OSU procedure by which UEs are enabled to access a data network via the NHN where the NHN comprises one or more APs that provide wireless access according to a cellular communications technology. The method of operation of the network node comprises: obtaining a filter list that defines limitations on a connectivity of a PDN connection established for OSU between a UE and PSP; and utilizing the filter list such that traffic on the PDN connection is limited to traffic between the UE and one or more other network nodes of the PSP that perform operations related to OSU.

Another embodiment of the present solution is directed to a network node in a NHN in relation to an OSU procedure by which UEs are enabled to access a data network via the NHN where the NHN comprises one or more APs that provide wireless access according to a cellular communications technology. The network node is adapted to operatively: obtain a filter list that defines limitations on a connectivity of a PDN connection established for OSU between a UE and a PSP, and utilize the filter list such that traffic on the PDN connection is limited to traffic between the UE and one or more network nodes of the PSP that perform operations related to OSU.

Another embodiment of the present solution is directed to a network node in a NHN in relation to an OSU procedure by which UEs are enabled to access a data network via the NHN where the NHN comprises one or more APs that provide wireless access according to a cellular communications technology. The network node comprises: at least one processor; and memory storing instructions executable by the at least one processor whereby the network node is operable to obtain a filter list that defines limitations on a connectivity of a PDN connection established for OSU between a UE and a PSP, and utilize the filter list such that traffic on the PDN connection is limited to traffic between the UE and one or more network nodes of the PSP that perform operations related to OSU.

Another embodiment of the present solution is directed to a network node in a NHN in relation to an OSU procedure by which UEs are enabled to access a data network via the NHN where the NHN comprises one or more APs that provide wireless access according to a cellular communications technology. The network node comprises: a filter list obtaining module operable to obtain a filter list that defines limitations on a connectivity of a PDN connection established for OSU between a UE and a PSP; and a filter list utilization module operable to utilize the filter list such that traffic on the PDN connection is limited to traffic between the UE and one or more other network nodes of the PSP that perform operations related to OSU.

The embodiments described herein address some or all problems listed above.

Those skilled in the art will appreciate the scope of the present disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an Online Sign Up (OSU) procedure as proposed for MulteFire Alliance (MFA);

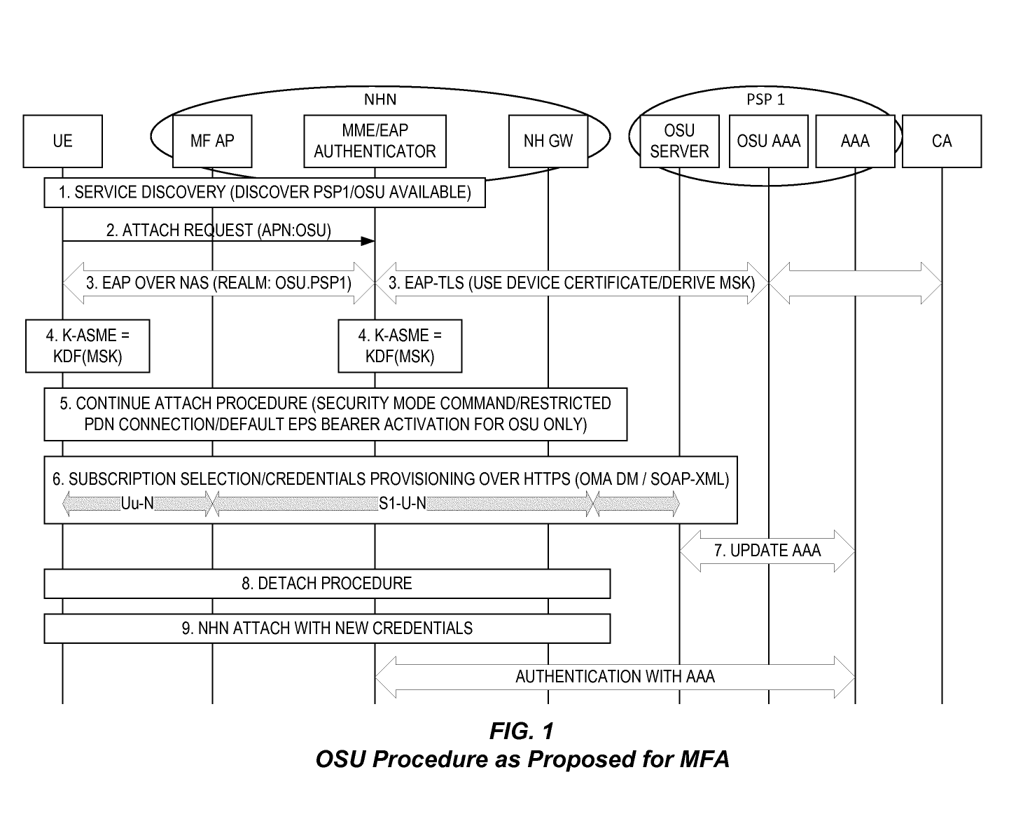

FIG. 2 illustrates an example of a Neutral Host Network (NHN) as specified by the MFA;

FIG. 3 illustrates an OSU procedure according to some embodiments of the present disclosure;

FIGS. 4 and 5 are block diagrams of a network node according to some embodiments of the present disclosure; and

FIGS. 6 and 7 are block diagrams of a User Equipment device (UE) according to some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

The present disclosure relates to an Online Sign Up (OSU) procedure for MulteFire, or more generally for standalone Long Term Evolution (LTE) in unlicensed spectrum. While MulteFire is referred to herein, the present disclosure is not limited to MulteFire; rather, the concepts disclosed herein can be utilized in any wireless system in which standalone cellular communications radio access nodes operate in unlicensed spectrum.

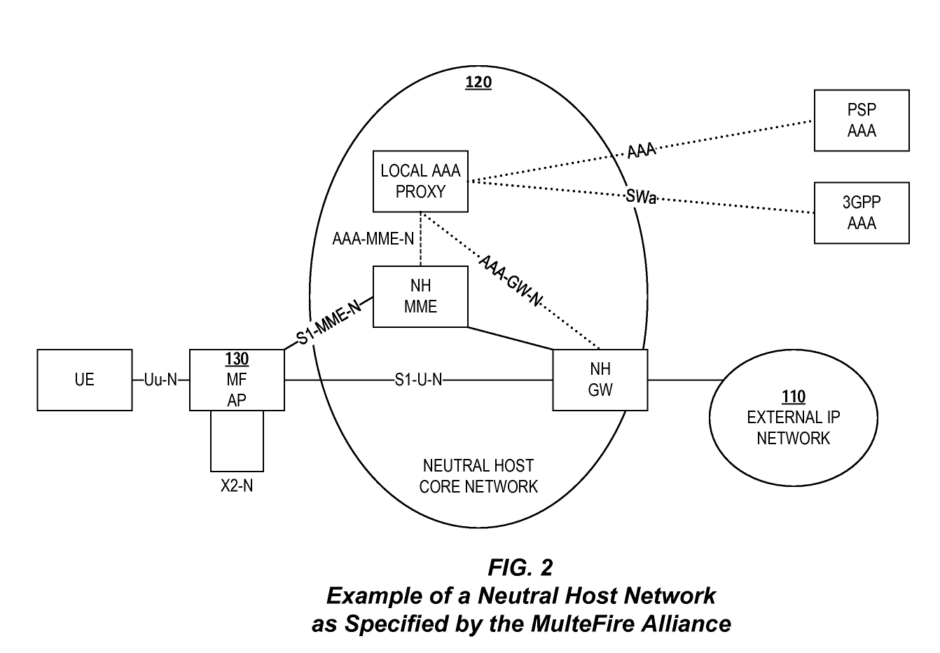

FIG. 2 illustrates one example of a Neutral Host Network (NHN) in which embodiments of the present disclosure may be implemented. As illustrated, the NHN includes a MulteFire (MF) Access Point (AP) and a Neutral Host Core Network (NHCN).

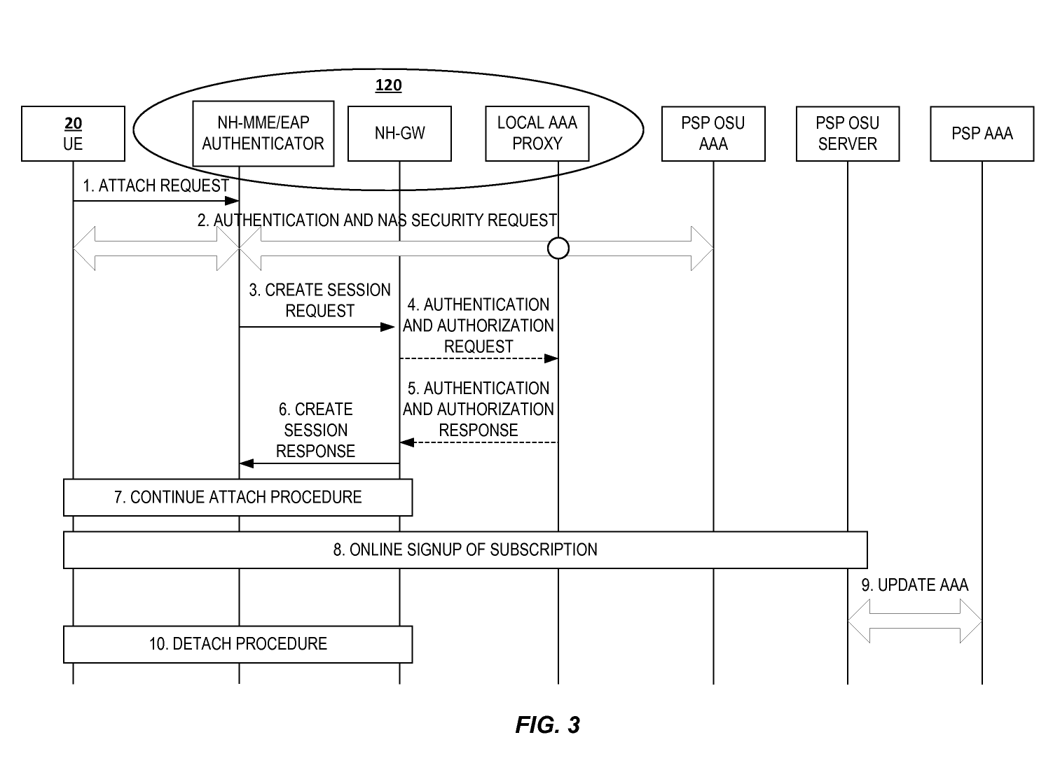

FIG. 3 illustrates the operation of the NHN of FIG. 2 to provide secure OSU according to some embodiments of the present disclosure.
1. The User Equipment device (UE) sends an attach request to the NHN and, in particular, to the Neutral Host (NH) Mobility Management Entity (MME)/Extensible Authentication Protocol (EAP) Authenticator in the NHCN. The attach request indicates that the request is for OSU. An indication of what Participating Service Provider (PSP) should be used for the OSU can either be indicated in the attach request or indicated in step 2.
2. The UE, the NHCN, and the PSP then communicate to perform authentication and Non-Access Stratum (NAS) security setup to activate integrity protection and NAS ciphering. EAP Transport Layer Security (TLS) between the UE and the PSP OSU AAA server via the NH MME/EAP authenticator. Messages carried over the NAS UE<->NH-MME and Diameter/RADIUS between the NH-MME and the PSP OSU AAA server. A Master Session Key (MSK) is derived during EAP-TLS. The UE is using a device certificate in this step to authenticate to the network.
   A new thing with the present disclosure is that the PSP OSU sends the OSU server Internet Protocol (IP) address and/or Fully Qualified Domain Name (FQDN) and/or Uniform Resource Locator (URL) to the UE in an EAP message. This can be encrypted so that the NHN can't read or modify it. This IP address and/or FQDN and/or URL points to the PSP OSU server(s).
   A new thing with the present disclosure is that the PSP OSU AAA server sends, to the NH-MME or the local AAA proxy or both, either a white or blacklist of IP addresses used to limit the connectivity of the OSU Packet Data Network (PDN) connection. Note that the PDN connection is setup as requested in step 1 and is ready after step 7. This list of IP addresses can be any filter that limits the connectivity of the PDN connection and in the rest of this disclosure this parameter is referred to as a “filter list.” The filter list can be stored in either the NH-MME or in the local AAA proxy or in both. Importantly, the filter list limits the connectivity of the PDN connection to only those IP address(es) that point to the PSP OSU server(s), thereby limiting the connectivity of the PDN connection to traffic for OSU.
3. The NH-MME/EAP Authenticator sends a Create Session Request to the NH Gateway (GW) (or the Serving Gateway (S-GW)/PDN Gateway (P-GW) in the NHN).
   A new thing with the present disclosure is that, in some embodiments, NH-MME includes the filter list received in step 2. This could either be the filter list directly or a parameter derived from the filter list. In some alternative embodiments, the NH-GW receives the filter list in steps 4 and 5.
4. A new thing with the present disclosure is that the NH-GW (or the P-GW in the NHN) optionally sends an authorization request to the local AAA proxy to request the filter list.
5. The local AAA proxy responds to the NH-GW (or the P-GW in the NHN) with the filter list the local AAA proxy received in step 2.
6. The NH-GW sends a Create Session Response to the NH-MME and/or EAP Authenticator. This can also be done before step 5.
   New thing with the present disclosure is that the NH-GW (or the P-GW in the NHN) uses the filter list received in either step 3 or in step 5 to allow only traffic to/from the destination derived from the filter-list for this PDN connection. In some embodiments, the NH-GW (e.g., P-GW) obtains the filter list, or filter(s), that will deny all traffic except the traffic to the IP address(es) of the OSU server(s). In that way, the PDN connection will be limited to only access the OSU server(s). The NH-GW will, by applying the filter list or the parameter(s) derived therefrom, ensure that only traffic to/from the PSP OSU server(s) is permitted for this PDN connection. Excess traffic is not allowed and dropped. The UE receives the OSU address to be used for the OSU, but there is no guarantee that the UE does not also use the PDN connection for other traffic. Hence, the filter-list ensures that the UE is only able to use the PDN connection for OSU.
7. The UE and the network continue the attach procedure as defined in Third Generation Partnership Project (3GPP) Technical Specification (TS) 23.401.
8. The UE initiates the Subscription selection and credentials provisioning with the OSU Server over Hypertext Transfer Protocol over Transport Layer Secure (HTTPS), using Open Mobile Alliance (OMA) Device Management (DM) or Simple Object Access Protocol (SOAP) Extensible Markup Language (XML), as defined for Hotspot (HS) 2.0. The OSU server shall request and the UE shall provide the device certificate. Validating the device certificate is up to the PSP policy.
   A new thing with the present disclosure is that the UE should validate a certificate from the PSP OSU server to verify that it is indeed setting up a new subscription with the correct PSP.
9. Upon successful provisioning of the device, the OSU server updates the AAA server about this new subscription information.
10. The Detach procedure is initiated, to remove the UE context for provisioning only. A Radio Resource Control (RRC) connection is released during the detach procedure.

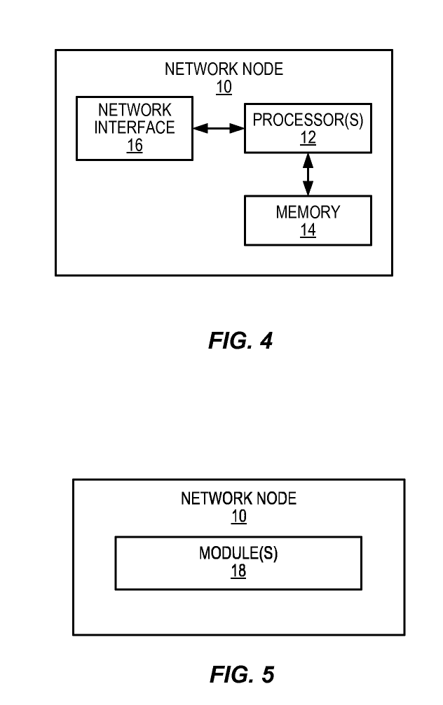

After this procedure, the UE can establish a new RRC connection and performs the attach procedure using the new set of credentials received during the OSU. FIG. 4 is a block diagram of a network node 10 according to some embodiments of the present disclosure. The network node 10 may be any node in the Neutral Host Core Network (NHCN) or any node of the PSP. For example, the network node 10 may be the NH-MME/EAP Authenticator, the NH-GW, or the local AAA proxy in the NHCN or the PSP OSU AAA server, PSP OSU server, or PSP OSU AAA server of the PSP. As illustrated, the network node 10 includes one or more processors 12 or processing circuits (e.g., one or more Central Processing Units (CPUs), one or more Application Specific Integrated Circuits (ASICs), one or more Field Programmable Gate Arrays (FPGAs), or the like, or any combination thereof), memory 14, and a network interface 16. In some embodiments, the functionality of the network node 10 described herein is implemented in software, stored in the memory 14, and executed by the processor(s) 12 whereby the network node 10 operates according to any of the embodiments described herein.

In some embodiments, a computer program including instructions which, when executed by at least one processor, causes the at least one processor to carry out the functionality of the network node 10 according to any one of the embodiments described herein is provided. In one embodiment, a carrier containing the aforementioned computer program product is provided. The carrier is one of an electronic signal, an optical signal, a radio signal, or a computer readable storage medium (e.g., a non-transitory computer readable medium such as the memory 14).

FIG. 5 is a block diagram of the network node 10 according to some other embodiments of the present disclosure. Again, the network node 10 may be any node in the NHCN or any node of the PSP. For example, the network node 10 may be the NH-MME/EAP Authenticator, the NH-GW, or the local AAA proxy in the NHCN or the PSP OSU AAA server, PSP OSU server, or PSP OSU AAA server of the PSP. The network node 10 includes one or more modules 18, each of which is implemented in software. The module(s) operate to provide the functionality of the network node 10 as described herein.

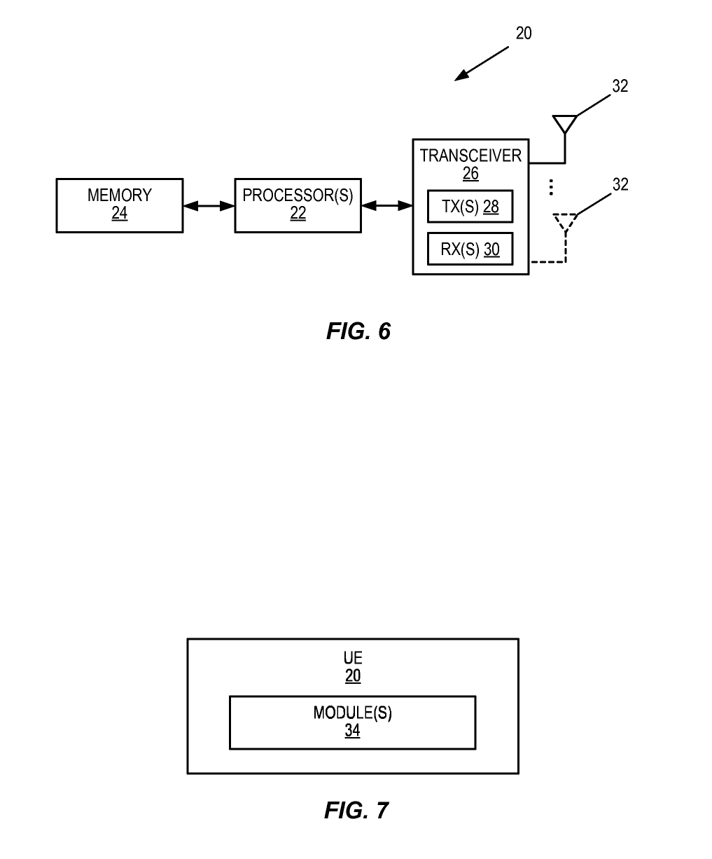

FIG. 6 is a block diagram of a UE 20 according to some embodiments of the present disclosure. As illustrated, the UE 20 includes one or more processors 22 or processing circuits (e.g., one or more CPUs, one or more ASICs, one or more FPGAs, or the like, or any combination thereof), memory 24, and one or more transceivers 26 including one or more transmitters 28 and one or more receivers 30 coupled to one or more antennas 32. In some embodiments, the functionality of the UE 20 described herein is implemented in software, stored in the memory 24, and executed by the processor(s) 22 whereby the UE 20 operates according to any of the embodiments described herein.

In some embodiments, a computer program including instructions which, when executed by at least one processor, causes the at least one processor to carry out the functionality of the UE 20 according to any one of the embodiments described herein is provided. In one embodiment, a carrier containing the aforementioned computer program product is provided. The carrier is one of an electronic signal, an optical signal, a radio signal, or a computer readable storage medium (e.g., a non-transitory computer readable medium such as the memory 24).

FIG. 7 is a block diagram of the UE 20 according to some other embodiments of the present disclosure. The UE 20 includes one or more modules 34, each of which is implemented in software. The module(s) 34 operate to provide the functionality of the UE 20 as described herein.

While not being limited to or by any particular example embodiment, some example embodiments of the present disclosure are provided below.

### Embodiment 1

A method of operation of a network node that performs Online Set Up, OSU, Authentication, Authorization, and Accounting, AAA, for a Participating Service Provider, PSP, to enable User Equipment devices, UEs, to access a data network via a Neutral Host Network, NHN, that comprises one or more Access Points, APs, that provide wireless access according to a cellular communications technology, comprising:
   providing, to a network node in the NHN, a filter list that defines limitations on a connectivity of a Packet Data Network, PDN, connection established for OSU between a UE and the PSP.

### Embodiment 2

The method of embodiment 1 wherein the filter list is such that Internet Protocol, IP, traffic to and from the UE via the PDN connection is limited to IP traffic between the UE and one or more network nodes of the PSP that perform operations related to OSU.

### Embodiment 3

The method of embodiment 1 or 2 wherein providing the filter list to the network node in the NHN comprises providing the filter list to a Mobility Management Entity, MME, in the NHN.

### Embodiment 4

The method of embodiment 1 or 2 wherein providing the filter list to the network node in the NHN comprises providing the filter list to a network node of the NHN that performs local AAA for the NHN.

### Embodiment 5

The method of any one of embodiments 1 to 4 further comprising providing, to the UE, an IP address of a network node of the PSP that performs operations related to the OSU.

### Embodiment 6

The method of embodiment 5 wherein providing, to the UE, the IP address of the network node of the PSP that performs operations related to the OSU comprises providing the IP address to the UE via an encrypted message that is not readable or modifiable by the NHN.

### Embodiment 7

A network node that performs Online Set Up, OSU, Authentication, Authorization, and Accounting, AAA, for a Participating Service Provider, PSP, to enable User Equipment devices, UEs, to access a data network via a Neutral Host Network, NHN, that comprises one or more Access Points, APs, that provide wireless access according to a cellular communications technology, the network node adapted to:
   provide, to a network node in the NHN, a filter list that defines limitations on a connectivity of a Packet Data Network, PDN, connection established for OSU between a UE and the PSP.

### Embodiment 8

The network node of embodiment 7 wherein the network node is further adapted to operate according to the method of any one of embodiments 1 to 6.

### Embodiment 9

A network node that performs Online Set Up, OSU, Authentication, Authorization, and Accounting, AAA, for a Participating Service Provider, PSP, to enable User Equipment devices, UEs, to access a data network via a Neutral Host Network, NHN, that comprises one or more Access Points, APs, that provide wireless access according to a cellular communications technology, the network node comprising:
   at least one processor; and
   memory storing instructions executable by the at least one processor whereby the network node is operable to provide, to a network node in the NHN, a filter list that defines limitations on a connectivity of a Packet Data Network, PDN, connection established for OSU between a UE and the PSP.

### Embodiment 10

A network node that performs Online Set Up, OSU, Authentication, Authorization, and Accounting, AAA, for a Participating Service Provider, PSP, to enable User Equipment devices, UEs, to access a data network via a Neutral Host Network, NHN, that comprises one or more Access Points, APs, that provide wireless access according to a cellular communications technology, the network node comprising:
   a filter list providing module operable to provide, to a network node in the NHN, a filter list that defines limitations on a connectivity of a Packet Data Network, PDN, connection established for OSU between a UE and the PSP.

### Embodiment 11

A method of operation of a network node in a Neutral Host Network, NHN, in relation to an Online Set Up, OSU, procedure by which User Equipment devices, UEs, are enabled to access a data network via the NHN where the NHN comprises one or more Access Points, APs, that provide wireless access according to a cellular communications technology, the method of operation of the network node comprising:
   obtaining a filter list that defines limitations on a connectivity of a Packet Data Network, PDN, connection established for OSU between a User Equipment device, UE, and a Participating Service Provider, PSP; and
   utilizing the filter list such that traffic on the PDN connection is limited to traffic between the UE and one or more network nodes of the PSP that perform operations related to OSU.

### Embodiment 12

The method of embodiment 11 wherein the network node in the NHN is a local Authentication, Authorization, and Accounting, AAA, proxy of the NHN, and utilizing the filter list comprises providing the filter list to a gateway of the NHN upon request.

### Embodiment 13

The method of embodiment 11 wherein the network node in the NHN is a Mobility Management Entity, MME, of the NHN, and utilizing the filter list comprises setting up the PDN connection such that the PDN connection can only be used for traffic between the UE and the one or more network nodes of the PSP that perform operations related to OSU.

### Embodiment 14

The method of embodiment 11 wherein the network node in the NHN is a Mobility Management Entity, MME, of the NHN, and utilizing the filter list comprises providing the filter list and/or one or more parameters derived from the filter list to a gateway of the NHN.

### Embodiment 15

The method of embodiment 11 wherein the network node in the NHN is a gateway of the NHN, and utilizing the filter list comprises filtering traffic on the PDN connection such that the PDN connection can only be used for traffic between the UE and the one or more network nodes of the PSP that perform operations related to OSU.

### Embodiment 16

A network node in a Neutral Host Network, NHN, in relation to an Online Set Up, OSU, procedure by which User Equipment devices, UEs, are enabled to access a data network via the NHN where the NHN comprises one or more Access Points, APs, that provide wireless access according to a cellular communications technology, the network node adapted to:
   obtain a filter list that defines limitations on a connectivity of a Packet Data Network, PDN, connection established for OSU between a User Equipment device, UE, and a Participating Service Provider, PSP; and
   utilize the filter list such that traffic on the PDN connection is limited to traffic between the UE and one or more network nodes of the PSP that perform operations related to OSU.

### Embodiment 17

The network node of embodiment 16 wherein the network node is further adapted to operate according to the method of any one of embodiments 12 to 15.

### Embodiment 18

A network node in a Neutral Host Network, NHN, in relation to an Online Set Up, OSU, procedure by which User Equipment devices, UEs, are enabled to access a data network via the NHN where the NHN comprises one or more Access Points, APs, that provide wireless access according to a cellular communications technology, the network node comprising:
   at least one processor; and
   memory storing instructions executable by the at least one processor whereby the network node is operable to:
      obtain a filter list that defines limitations on a connectivity of a Packet Data Network, PDN, connection established for OSU between a User Equipment device, UE, and a Participating Service Provider, PSP; and
      utilize the filter list such that traffic on the PDN connection is limited to traffic between the UE and one or more network nodes of the PSP that perform operations related to OSU.

### Embodiment 19

A network node in a Neutral Host Network, NHN, in relation to an Online Set Up, OSU, procedure by which User Equipment devices, UEs, are enabled to access a data network via the NHN where the NHN comprises one or more Access Points, APs, that provide wireless access according to a cellular communications technology, the network node comprising:
   a filter list obtaining module operable to obtain a filter list that defines limitations on a connectivity of a Packet Data Network, PDN, connection established for OSU between a User Equipment device, UE, and a Participating Service Provider, PSP; and
   a filter list utilization module operable to utilize the filter list such that traffic on the PDN connection is limited to traffic between the UE and one or more network nodes of the PSP that perform operations related to OSU.

The following acronyms are used throughout this disclosure.
3GPP Third Generation Partnership Project
AAA Authentication, Authorization, and Accounting
AP Access Point
APN Access Point Name
ASME Access Security Management Entity
ASIC Application Specific Integrated Circuit
CA Carrier Aggregation
CPU Central Processing Unit
DM Device Management
EAP Extensible Authentication Protocol
EPC Evolved Packet Core
FPGA Field Programmable Gate Array
FQDN Fully Qualified Domain Name
GHz Gigahertz
GTPv2 General Packet Radio Service Tunneling Protocol version 2
GW Gateway
HS Hotspot
HTTPS Hypertext Transfer Protocol over Transport Layer Secure
ID Identity
IP Internet Protocol
LAA License Assisted Access
LTE Long Term Evolution
LTE-U Long Term Evolution in Unlicensed Spectrum
MF MulteFire
MFA MulteFire Alliance
MME Mobility Management Entity
MSK Master Session Key
NAS Non-Access Security
NH Neutral Host
NHCN Neutral Host Core Network
NHN Neutral Host Network
OMA Open Mobile Alliance
OSU Online Sign Up
PDN Packet Data Network
P-GW Packet Data Network Gateway
PLMN Public Land Mobile Network
PSP Participating Service Provider
RRC Radio Resource Control
S-GW Serving Gateway
SMC Security Mode Command
SOAP Simple Object Access Protocol
TFT Traffic Flow Template
TLS Transport Layer Security
TS Technical Specification
UE User Equipment
URL Uniform Resource Locator
XML Extensible Markup Language

Those skilled in the art will recognize improvements and modifications to the embodiments of the present disclosure. All such improvements and modifications are considered within the scope of the concepts disclosed herein.

1. A method of operation of a network node that performs Online Set Up, OSU, Authentication, Authorization, and Accounting, AAA, for a Participating Service Provider, PSP, to enable User Equipment devices, UEs, to access a data network via a Neutral Host Network, NHN, that comprises one or more Access Points, APs, that provide wireless access according to a cellular communications technology, comprising:
providing, to another network node in the NHN, a filter list that defines limitations on a connectivity of a Packet Data Network, PDN, connection established for OSU between a UE and the PSP.

2. The method according to claim 1 wherein the filter list is such that Internet Protocol, IP, traffic to and from the UE via the PDN connection is limited to IP traffic between the UE and one or more other network nodes of the PSP that perform operations related to OSU.

3. The method according to claim 1 wherein providing the filter list to the network node in the NHN comprises providing the filter list to a Mobility Management Entity, MME, in the NHN.

4. The method according to claim 1 wherein providing the filter list to the network node in the NHN comprises providing the filter list to a network node of the NHN that performs local AAA for the NHN.

5. The method according to claim 1 further comprising providing, to the UE, an IP address of a network node of the PSP that performs operations related to the OSU.

6. The method according to claim 5 wherein providing, to the UE, the IP address of the network node of the PSP that performs operations related to the OSU comprises providing the IP address to the UE via an encrypted message that is not readable or modifiable by the NHN.

7. (canceled)

8. (canceled)

9. A network node that performs Online Set Up, OSU, Authentication, Authorization, and Accounting, AAA, for a Participating Service Provider, PSP, to enable User Equipment devices, UEs, to access a data network via a Neutral Host Network, NHN, that comprises one or more Access Points, APs, that provide wireless access according to a cellular communications technology, the network node comprising:
at least one processor; and
memory storing instructions executable by the at least one processor whereby the network node is operable to provide, to another network node in the NHN, a filter list that defines limitations on a connectivity of a Packet Data Network, PDN, connection established for OSU between a UE and the PSP.

10. (canceled)

11. A method of operation of a network node in a Neutral Host Network, NHN, in relation to an Online Set Up, OSU, procedure by which User Equipment devices, UEs, are enabled to access a data network via the NHN where the NHN comprises one or more Access Points, APs, that provide wireless access according to a cellular communications technology, the method of operation of the network node comprising:
obtaining a filter list that defines limitations on a connectivity of a Packet Data Network, PDN, connection established for OSU between a UE and a Participating Service Provider, PSP; and
utilizing the filter list such that traffic on the PDN connection is limited to traffic between the UE and one or more other network nodes of the PSP that perform operations related to OSU.

12. The method according to claim 11 wherein the network node in the NHN is a local Authentication, Authorization, and Accounting, AAA, proxy of the NHN, and utilizing the filter list comprises providing the filter list to a gateway of the NHN upon request.

13. The method according to claim 11 wherein the network node in the NHN is a Mobility Management Entity, MME, of the NHN, and utilizing the filter list comprises setting up the PDN connection such that the PDN connection can only be used for traffic between the UE and the one or more network nodes of the PSP that perform operations related to OSU.

14. The method according to claim 11 wherein the network node in the NHN is a Mobility Management Entity, MME, of the NHN, and utilizing the filter list comprises providing the filter list and/or one or more parameters derived from the filter list to a gateway of the NHN.

15. The method according to claim 11 wherein the network node in the NHN is a gateway of the NHN, and utilizing the filter list comprises filtering traffic on the PDN connection such that the PDN connection can only be used for traffic between the UE and the one or more network nodes of the PSP that perform operations related to OSU.

16. (canceled)

17. (canceled)

18. A network node in a Neutral Host Network, NHN, in relation to an Online Set Up, OSU, procedure by which User Equipment devices, UEs, are enabled to access a data network via the NHN where the NHN comprises one or more Access Points, APs, that provide wireless access according to a cellular communications technology, the network node comprising:
at least one processor; and
memory storing instructions executable by the at least one processor whereby the network node is operable to:
obtain a filter list that defines limitations on a connectivity of a Packet Data Network, PDN, connection established for OSU between a UE and a Participating Service Provider, PSP; and
utilize the filter list such that traffic on the PDN connection is limited to traffic between the UE and one or more network nodes of the PSP that perform operations related to OSU.

19. (canceled)
